(19) United States
(12) Patent Application Publication
(10) Pub. No.: US 2025/0361930 A1
(43) Pub. Date: Nov. 27, 2025

(54) INTEGRATED DIFFERENTIAL LOCK SYSTEM

(71) Applicant: DANA ITALIA S.R.L., Arco (IT)

(72) Inventors: Gianluca TERRASI, Arco (IT); Gian Mario RAVASI, Riva del Garda (IT); Davide DEIMICHEI, Ala (IT)

(21) Appl. No.: 19/179,819

(22) Filed: Apr. 15, 2025

Related U.S. Application Data
(60) Provisional application No. 63/639,795, filed on Apr. 29, 2024.

(51) Int. Cl. F16H 48/22; F16H 48/32

(52) U.S. Cl. CPC F16H 48/22; F16H 48/32

(57) ABSTRACT

The application relates to a differential lock assembly comprising: a differential; a friction pack; and a piston bearing actuator system comprising a piston, a bearing, and an actuator abutting the friction pack, where the piston is an outer race for the bearing and the actuator is an inner race for the bearing. The friction pack may be a disk pack.

Further, an axle assembly comprising: a first housing; a first axle shaft; a second axle shaft; and the differential lock assembly. And, the application relates to a method of assembling the differential lock assembly and the piston bearing actuator assembly thereof.

### CROSS REFERENCE TO RELATED APPLICATIONS

The present application claims priority to U.S. Provisional Application No. 63/639,795, entitled “INTEGRATED DIFFERENTIAL LOCK SYSTEM”, and filed on Apr. 29, 2024. The entire contents of the above-listed application are hereby incorporated by reference for all purposes.

### TECHNICAL FIELD

The present description to a system of a piston and an actuator to close a clutch that may selectively couple opposite shafts across a differential.

### BACKGROUND AND SUMMARY

Vehicles may have a plurality of configurations of axle assemblies that include a differential. Vehicles, such as off-highway vehicles, may include differentials of a locked configuration, alternatively referred to as a closed configuration. Locked configuration differentials incorporate a clutch that when closed rigidly couples the first shaft and second shaft via the differential. When rigidly coupled via the clutch, torque may be distributed equally between the first shaft and the second shaft via the differential, and the first shaft and second shaft may rotate at the same rotational speed. Rigid coupling may be used for modes of operation for the vehicle such as driving the vehicle on snow, ice, or other conditions. The clutch of the closed differential may be a friction clutch, closed via a piston and an actuator. The piston may be translated hydraulically. The actuator may be translated in the same direction as the piston. When translated, the actuator may contact and press against a clutch pack of the clutch to close the clutch. A bearing assembly including one or more bearings may be positioned radially between piston and the actuator, such that the actuator may rotate freely of the actuator. Collectively, the piston, bearing system, and the actuator may be referred to as a piston bearing actuator system.

The bearing system may have an inner and outer race. The outer race may contact and be retained by the piston. The inner race may contact and be retained by the actuator. Such an arrangement may produce challenges. For example, components of the piston bearing actuator system may experience increased degradation from wear and seizure of the components. Seizure of components may prevent or reduce the speed at which the clutch may be close. Likewise, the outer race and inner race may increase the size of the piston bearing actuator system relative to a piston system without a bearing. Additionally, creating features to retain the inner and outer races may reduce the strengths, including: tensile, compressive, and sheer strengths, of the piston and the actuator.

The inventors herein have recognized these and other issues with such systems and have developed a way to at least partially solve them. In one example, a differential lock assembly is provided comprising: a friction pack; and a piston bearing actuator system comprising a piston, a bearing, and an actuator abutting the disk pack, where the piston is an outer race for the bearing and the actuator is an inner race for the bearing.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic of a vehicle which may include an axle assembly with a differential lock assembly of the present disclosure.

FIG. 2 shows a sectional view of an axle assembly including the differential locking assembly.

FIG. 3 shows a sectional view of an area including a piston bearing actuator system of the present disclosure.

FIG. 4 shows a method of assembling the piston bearing actuator system and the differential locking assembly.

FIG. 5 shows a method of closing clutch via the piston bearing actuator system.

### DETAILED DESCRIPTION

The following description relates to a piston bearing actuator system of a differential system for an axle assembly, where the differential of the differential system is a locked differential (e.g., a closed differential). The piston bearing actuator system includes a piston, a bearing system, and an actuator. The bearing system is one or more bearings that may be positioned radially between the piston and the actuator. The piston comprises an integrated section formed as one piece with the piston without welds, seams, or other couplings, where the section is an outer race for the one or more bearings. Likewise, the actuator is an inner race for the one or more bearings formed as one piece with the actuator without welds, seams, or other couplings. The section of the piston may curve radially around the piston and the opening may surround the piston. The bearing system may be retained via the section by a first groove of the outer race. Likewise, the bearing system may be retained via the actuator by a second groove of the inner race. When retained by the first groove and second groove, the bearing system may allow the actuator to rotate independently (e.g., freely) of the piston. Likewise, when retained by the first groove and the second groove, the bearing system may couple the actuator and the piston, such that the piston may translate the actuator in an axial direction. The axial direction is a direction parallel with an axis that the piston bearing actuator system is centered about. The differential system also includes a component with anti-rotational function. The component may prevent the piston from rotating independently of an axle housing. For example, the component may be a pin. The pin may be received by a first volume of an axle housing for the axle assembly and a second volume the piston. When received by the first volume and the second volume, the pin may at least reduce and may prevent the rotation of the piston independently of the axle housing.

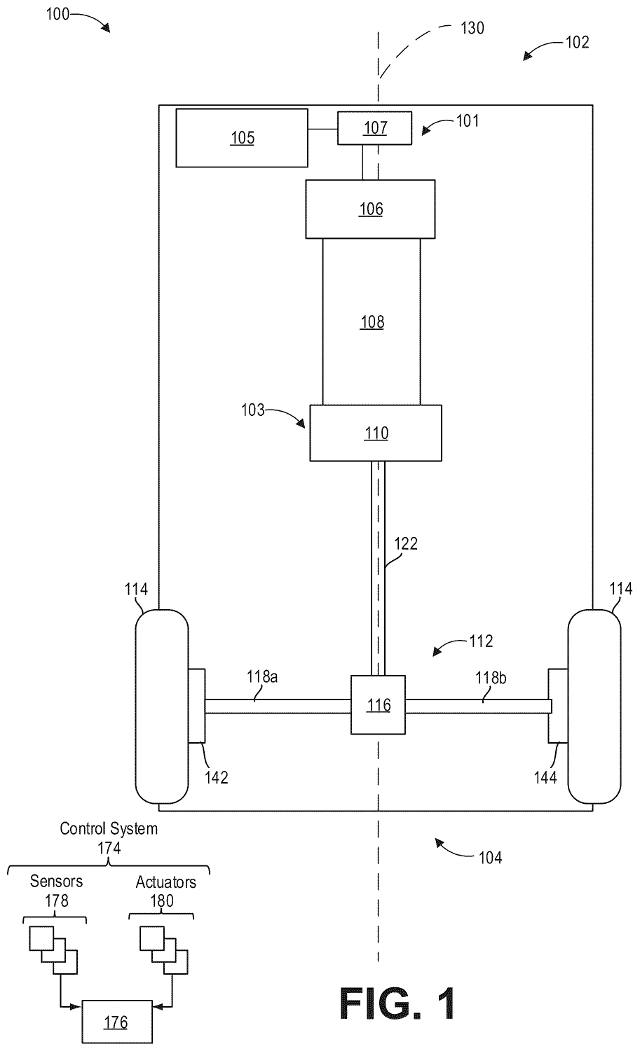

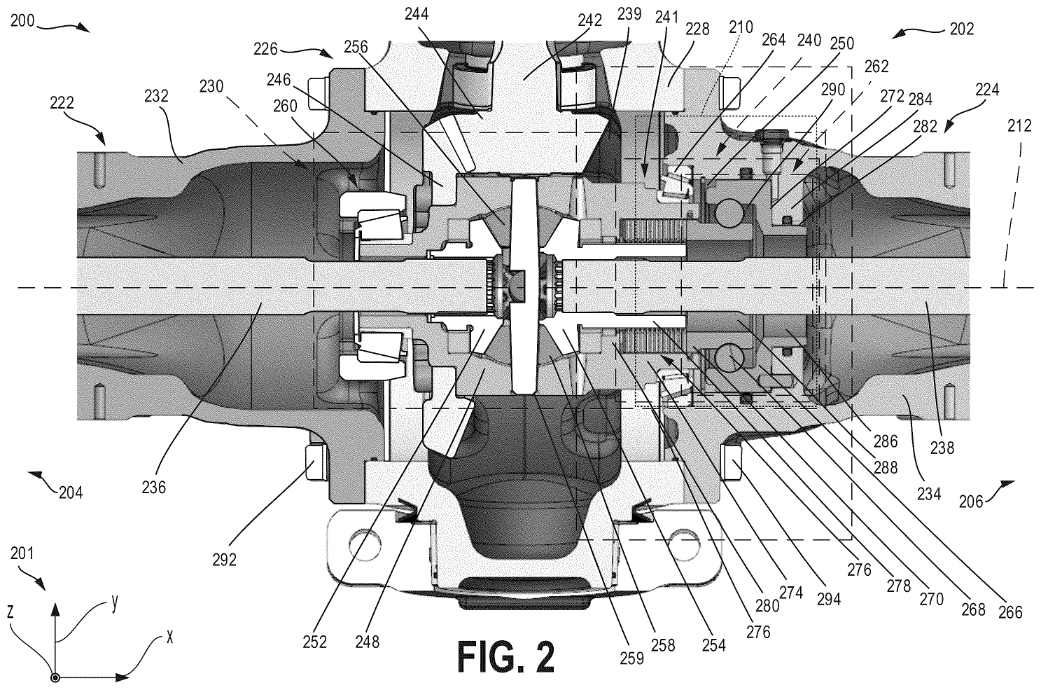

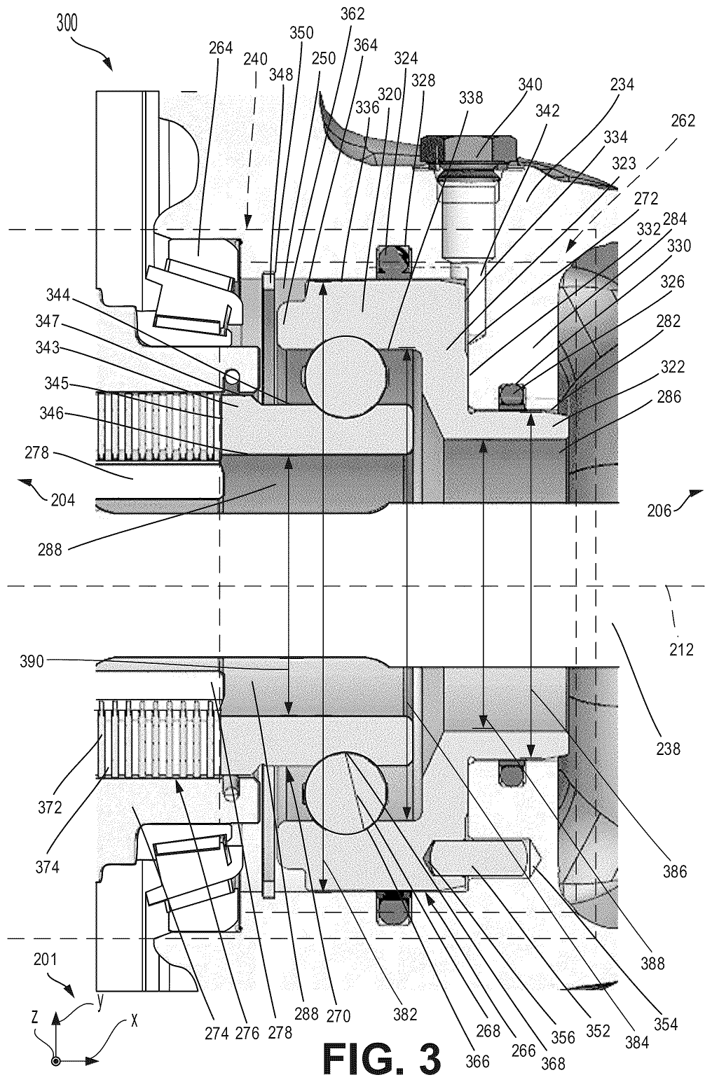

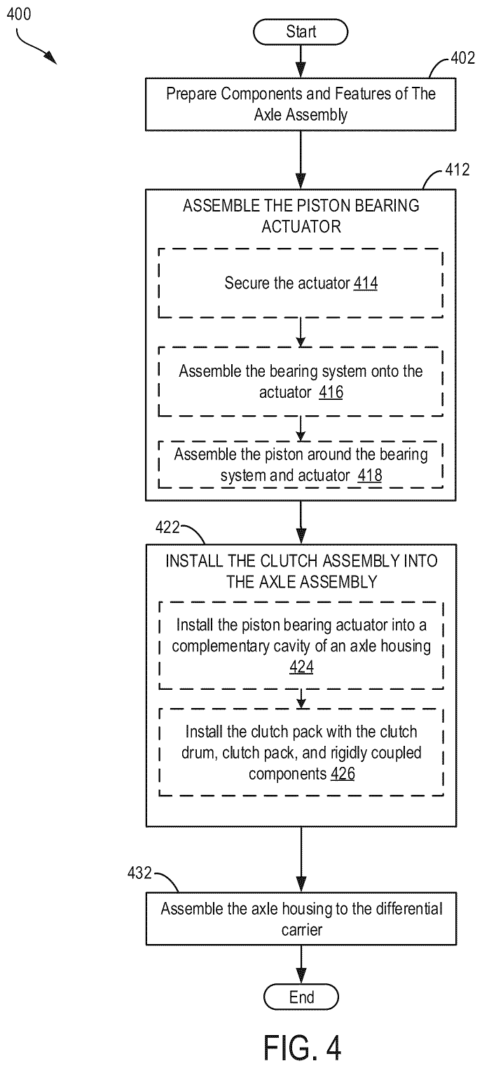

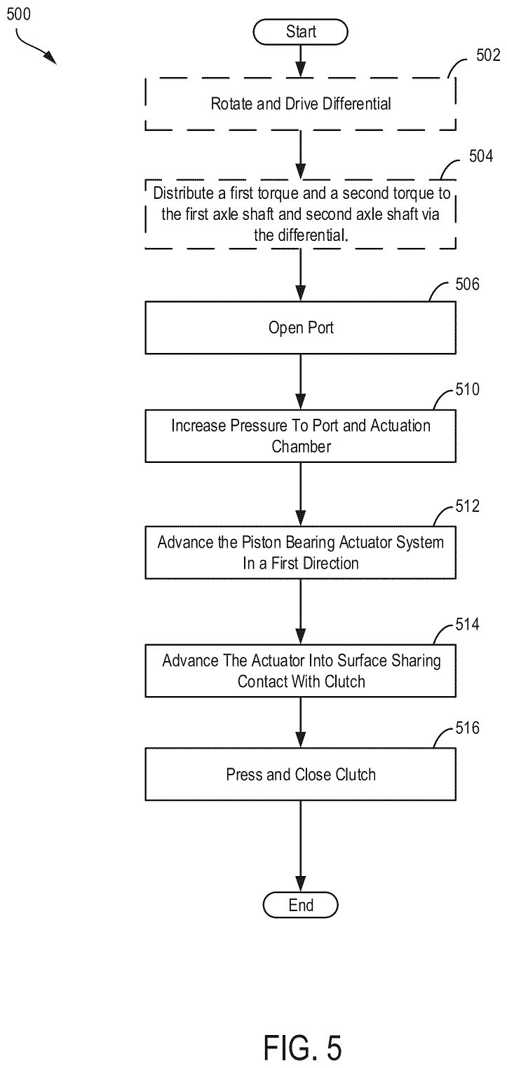

FIG. 1 shows an example schematic of a vehicle which may include an axle assembly with a differential lock assembly of the present disclosure. FIG. 2 shows a sectional view of an axle assembly including the differential lock assembly. The differential lock assembly includes a piston bearing actuator system of the present disclosure. The piston bearing actuator system includes a piston and an actuator that comprise the inner and outer races of a bearing system. FIG. 3 shows a sectional view of an area including a piston bearing actuator system of the present disclosure. FIG. 4 shows a method of assembly for the piston bearing actuator system and the differential lock assembly. FIG. 5 shows a method of closing a clutch via the piston bearing actuator system.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 shows a schematic of an example configuration with relative positioning of the various components. FIGS. 2-3 show example configurations with approximate position. FIGS. 2-3 are shown approximately to scale; though other relative dimensions may be used. As used herein, the terms “approximately” is construed to mean plus or minus five percent of the range unless otherwise specified.

Further, FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified.

Features described as longitudinal may be approximately parallel with an axis that is longitudinal. A lateral axis may be normal to a longitudinal axis and a vertical axis. Features described as lateral may be approximately parallel with the lateral axis. A vertical axis may be normal to a lateral axis and a longitudinal axis. Features described as vertical may be approximately parallel with a vertical axis.

Features described as drivingly coupled are coupled such as to drive one another. Said in another way, a first component drivingly coupled to a second component may drive the second component and vice versa. Said in another way, rotational power may be transferred from a first component to a second component when the first component drivingly couples the second component. A component described as a driving component may drive another component. A component described as a driven component may be driven by another component or feature.

Turning to FIG. 1, a vehicle 100 is shown comprising a powertrain 101 and a drivetrain 103. The vehicle 100 may have a front end 102 and a rear end 104, located on opposite sides of vehicle 100. Objects, components, and features of the vehicle 100 referred to as being located near the front may be closest to the front end 102 compared to the rear end 104. Objects, components, and features of the vehicle 100 referred to as being located near the rear may be closest to the rear end 104 compared to the front end 102. The vehicle 100 may have a longitudinal axis 130. The powertrain 101 and drivetrain 103 may have a length parallel with the longitudinal axis 130.

The powertrain 101 comprises a prime mover 106 and a transmission 108. For an example, the prime mover 106 may be an internal combustion engine (ICE). For another example, the prime mover 106 may be an electric machine. The prime mover 106 is operated to provide rotary power to the transmission 108. The transmission 108 receives the rotary power produced by the prime mover 106 as an input and outputs rotary power to the drivetrain 103 in accordance with a selected gear or setting.

The vehicle 100 may be a commercial vehicle, light, medium, or heavy duty vehicle, a passenger vehicle, an off-highway vehicle, a commercial vehicle, agricultural vehicle, and/or sport utility vehicle. For an example embodiment, the vehicle 100 may be a wheeled vehicle, such as an automobile. However, additionally or alternatively, the vehicle 100 may be plane, a boat, or other vehicle system. Additionally or alternatively, the vehicle 100 and/or one or more of its components, such as components of the powertrain 101 and/or the drivetrain 103, may be used in industrial, locomotive, military, agricultural, and/or aerospace applications. In an example, the vehicle 100 is an all-electric vehicle or a vehicle with all-electric modes of operation, such as a plug-in hybrid vehicle. As such, the prime mover 106 may be an electric machine, such as an electric motor/generator. For an example, the vehicle 100 may be a hybrid vehicle, wherein there are multiple torque inputs to the transmission 108. As such there may be at least another mover with an input to the transmission 108 besides prime mover 106. If the prime mover is an ICE or another non-electric machine mover, the other mover may be an electric machine, such as an electric motor or an electric motor/generator.

The prime mover 106 may be powered via energy from an energy storage device 105. For example, the energy storage device 105 is a battery, such as a traction battery, configured to store electrical energy. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The drivetrain 103 is shown in a rear-wheel drive configuration, although other configurations are possible. For one or more examples, the drivetrain 103 may include a front-wheel drive, a four-wheel drive configuration, or an all-wheel drive configuration. As such, the drivetrain 103 may have other configurations without departing from the scope of this disclosure, and the configuration shown in FIG. 1 is provided for illustration, not limitation.

The drivetrain 103 may include an axle assembly 112. The axle assembly 112 may be configured to drive a set of wheels 114. In one example, the axle assembly 112 is arranged near the rear of the vehicle 100 and thereby comprises a rear axle. For another example, the axle assembly 112 may be arranged near the front of the vehicle 100 and thereby comprise a front axle. Further, the drivetrain 103 may include one or more tandem axle assemblies. For other examples, there may be one or more axle assemblies in addition to axle assembly 112. For example, there may be an additional axle assembly arranged near the front of the vehicle 100 separate from the axle assembly 112. The additional axle assembly may be drivingly coupled to a transmission such as to be driven by torque or other rotational energy therefrom. For example, the additional axle may be drivingly coupled to the transmission 108 or another transmission. The vehicle 100 may include additional wheels and axles that are not coupled to the drivetrain 103. As such, the drivetrain 103 may have other configurations without departing from the scope of this disclosure, and the configuration shown in FIG. 1 is provided for illustration, not limitation.

The vehicle 100 may have a driveshaft 122. The transmission 108 may be drivingly coupled the axle assembly 112 via the driveshaft 122. Said in another way, the transmission 108 may drivingly couple to the driveshaft 122, and the driveshaft 122 may drivingly couple the axle assembly 112. In some configurations, such as shown in FIG. 1, the drivetrain 103 includes a transfer case 110 configured to receive rotary power output by the transmission 108. The driveshaft 122 may drivingly couple to the transfer case 110 and may be drivingly coupled to the transmission 108 via the transfer case 110.

The transmission 108 may be a gearbox. Alternatively, the transmission 108 may be an axle transmission or a trans axle transmission, and may be arranged or be part of an axle assembly such as the axle assembly 112. In some embodiments, additionally or alternatively, the transmission 108 may be a first transmission, and the vehicle 100 may have one or more other transmissions, such as a second transmission. For an example, the second transmission may be arranged nearer to the rear side or in another position of the vehicle 100 compared to transmission 108.

The axle assembly 112 may include a differential 116 and a first set of axle shafts. The differential 116 may drivingly couple the first set of axle shafts such as to transfer torque to and drive the first set of axle shafts. The first set of axle shafts may include a first shaft 118a and a second shaft 118b. The first shaft 118a and the second shaft 118b may be axle half shafts. The differential 116 may distribute unequal torque to wheel drivingly coupled at opposite ends of the axle assembly 112. For example, the differential 116 may distribute unequal torque to the first shaft 118a and the second shaft 118b.

The shafts 118a, 118b may drivingly couple to the set of wheels 114 via a set of wheel end assemblies. For example, the set of wheel end assemblies may include a first wheel end assembly 142 and a second wheel end assembly 144. The first wheel end assembly 142 may drivingly couple to one or more wheels of the set of wheels 114. Likewise, the second wheel end assembly 144 may drivingly couple to one or more wheels of the set of wheels 114. Wheels drivingly coupled to the first wheel end assembly 142 may be opposite the axle assembly 112 from the wheels drivingly coupled to the second wheel end assembly 144. Torque output by the differential 116 to the first shaft 118a may drive the first wheel end assembly 142 and one or more wheels of the wheels 114 coupled to the first wheel end assembly 142. Torque output by the differential 116 to the second shaft 118b may drive the second wheel end assembly 144 and one or more wheels of the wheels 114 coupled to the second wheel end assembly 144.

Adjustment of the drivetrain 103 between the various modes of operation as well as control of operations within each mode may be executed based on a vehicle control system 174, including a controller 176. Controller 176 may be a microcomputer, including elements such as a microprocessor unit, input/output ports, an electronic storage medium for executable programs and calibration values, e.g., a read-only memory chip, random access memory, keep alive memory, and a data bus. The storage medium can be programmed with computer readable data representing instructions executable by a processor for performing the methods described below as well as other variants that are anticipated but not specifically listed. In one example, controller 176 may be a powertrain control module (PCM).

Controller 176 may receive various signals from sensors 178 coupled to various regions of vehicle 100. For example, the sensors 178 may include sensors at the prime mover 106 or another mover to measure mover speed and mover temperature, a pedal position sensor to detect a depression of an operator-actuated pedal, such as an accelerator pedal or a brake pedal, a lever position sensor to detect a shifting of a lever, such as a brake lever, speed sensors at the set of wheels 114 etc. Upon receiving the signals from the various sensors 178 of FIG. 1, controller 176 processes the received signals, and employs various actuators 180 of vehicle 100 to adjust drivetrain operations based on the received signals and instructions stored on the memory of controller 176. For example, controller 176 may receive an indication of depression of the brake pedal, signaling a desire for decreased vehicle speed. Vehicle braking may be directly proportional to accelerator pedal position, for example, degree of depression. For another example, controller 176 may receive an indication of depression of the accelerator pedal, signaling a desire for increased vehicle speed. Vehicle acceleration may be directly proportional to accelerator pedal position, for example, degree of depression. In response, the controller 176 may command operations, such as shifting gear modes of the transmission 108. Alternatively, the gear modes of the transmission 108 may be shifted manually, such as if the transmission 108 is a manual transmission.

A set of reference axes 201 are provided for comparison between views shown in FIGS. 2-3. The reference axes 201 indicate a y-axis, an x-axis, and a z-axis. In one example, the z-axis may be parallel with a direction of gravity, and the x-y plane may be parallel with a horizontal plane that an axle assembly 202 of FIG. 2 may rest upon. A circle may represent an axis of the reference axes 201 that is normal to a view. A circle may represent an axis of the reference axes 201 that is normal to a view. A filled circle may represent an arrow and axis facing toward, or positive to, a view. An unfilled circle may represent an arrow and an axis facing away, or negative to, a view.

Turning to FIG. 2, a first view 200 of the axle assembly 202 is shown. The first view 200 is a sectional view of the axle assembly 202. The axle assembly 202 has a first side 204 and a second side 206, where the first side 204 is opposite the second side 206. First view 200 includes an area 210 enclosed by a plurality of dotted lines. Another figure and view may be taken on area 210. The axle assembly 202 may be the axle assembly 112 of FIG. 1.

The axle assembly 202 is centered on an axis 212. The axis 212 may be a longitudinal axis for the axle assembly 202, and directions parallel with the axis 212 may be referred to as longitudinal herein. However, it is to be appreciated that relative to a vehicle, such as the vehicle 100 of FIG. 1, the axis 212 may be a lateral axis.

The axle assembly 202 may include a first section 222, second section 224, and a differential assembly 226. The differential assembly 226 is sandwiched between the first section 222 and second section 224. The differential assembly 226 may be or include the first differential 116 of FIG. 1. The first section 222 and second section 224 may couple to the differential assembly 226. The first section 222 is positioned nearest to the first side 204. The second section 224 is positioned nearest to the second side 206. The first section 222 may output torque from the differential assembly 226 to at least a first wheel of a set of wheels. The second section 224 may output torque from the differential assembly 226 to at least a second wheel of a set of wheels.

The differential assembly 226 may include a differential system 230 enclosed and housed by a first housing 228 and a third housing 234. The axle assembly 202 also includes a second housing 232. The first housing 228 is a differential housing, such as a differential carrier or a differential cover that houses components of the differential assembly. Further the first housing 228 may house another differential housing, such as a differential case or another differential carrier, and the differential thereof that may rotate separately (e.g., freely) from the first housing 228. The first housing 228 may be centrally located with respect to the axle assembly 202, where the first housing 228 may be between the first section 222 and the second section 224. Said in another way, the first housing 228 may be a central housing for the differential for the axle assembly 202. Further, the first housing 228 is an axle housing. Likewise, the second housing 232 and third housing 234 are axle housings that may each house an axle shaft. For example, the second housing 232 may house a first axle shaft 236. Likewise, the third housing 234 may house a second axle shaft 238. The first axle shaft 236 and the second axle shaft 238 may be axle half shafts. The first axle shaft 236 and the second axle shaft 238 may be centered radially about the axis 212. The first axle shaft 236 and the second axle shaft 238 may each drivingly couple a wheel hub assembly, such as to drive the wheel hub assembly. The first axle shaft 236 may be the first shaft 118a of FIG. 1. Likewise, the second axle shaft 238 may be the second shaft 118b of FIG. 1.

The first housing 228 may be rigidly coupled and physically coupled to the second housing 232 and the third housing 234. For example, the second housing 232 may be rigidly coupled to the first housing 228 via a plurality of first fasteners 292. Likewise, the third housing 234 may be rigidly coupled to the first housing 228 via a plurality of second fasteners 294.

The first housing 228 comprises a first cavity 239. The third housing 234 comprises a second cavity 250. The first cavity 239 and the second cavity 250 may surround the differential system 230. The differential system 230 is a differential gear set and includes a differential lock assembly 240. Further a fourth housing (e.g., a rotatable and central differential housing) may be a part of the differential system 230 and the differential lock assembly 240. The fourth housing may be a housing that houses and supports (e.g., mechanically and rotationally supports) gears of the differential system 230. Said in another way, the fourth housing may be differential carrier (e.g., a differential carrier case or differential case). The fourth housing may be housed via at least the first housing 228 and may have portions housed via another housing of the axle assembly, such as the second housing 232 or the third housing 234. For example, the fourth housing may be housed via the first housing 228 and the third housing 234.

The fourth housing may be a differential cage 248, for an example. The fourth housing may be referred to interchangeably herein as the differential cage 248. And it is to be appreciated, that other types of differential carriers, differential cases, and other differential housings may be used in place of the differential cage 248 and have similar features that are a part of the differential lock assembly 240 (e.g., a drum 274 and other features that rigidly couple a clutch 241 and components thereof to the fourth housing).

The differential system 230 may drivingly couple to the first axle shaft 236 and the second axle shaft 238, such as to drive the first axle shaft 236 and the second axle shaft 238, such as via torque. The differential lock assembly 240 includes the clutch 241. The clutch 241 may have a plurality of locking features rigidly coupled to the differential cage 248. The clutch 241 is a friction clutch. As a friction clutch, the clutch 241 may be a wet clutch. The clutch 241 may have an open state and a closed state. When the clutch 241 is in an open state (e.g., opened), the differential system 230 may drive the first axle shaft 236 and the second axle shaft 238 to rotate at different rotational speeds and torques. When the clutch 241 is in a closed state (e.g., closed), the differential system 230 may drive the first axle shaft 236 and the second axle shaft 238 to rotate at the same rotational speeds and torques. Additionally, when the clutch 241 is in a closed state, the first axle shaft 236 and second axle shaft 238 may be rigidly coupled via the differential cage 248 and the clutch 241. Said in another way, when the clutch 241 is in a closed state, the clutch 241 locks the first axle shaft 236, the second axle shaft 238, and the differential cage 248.

A drive shaft 242 may be an input and drivingly couple to the differential system 230. The drive shaft 242 may rigidly couple or comprise a pinion gear 244. The pinion gear 244 may mesh and drivingly couple to the differential gear set of the differential system 230. The differential system 230 may include an input gear, at least two of a plurality of side gears, and one or more differential pinion gears (e.g., differential planet gears). The input gear may receive rotational energy, such as via torque, from an input, such as the pinion gear 244. Further the differential may be driven and rotatable via the torque and/or rotational energy from the input, and therein the input may drive the differential to rotate around the axis 212 via the input gear. The input gear may mesh with the pinion gear 244 or another example of the input.

For example, the differential gear set of the differential system 230 includes a ring gear 246, a first side gear 252, a second side gear 254, a first differential gear 256 (e.g., a first differential pinion gears), and a second differential gear 258 (e.g., a second differential pinion gear). The ring gear 246 may be the input gear. It is to be appreciated, there may be more differential pinion gears than the first differential gear 256 and the second differential gear 258, such as four differential pinion gears including the first differential gear 256 and the second differential gear 258.

The ring gear 246 may be positioned around at least a portion of the differential cage 248, such as radially around the portion of the differential cage 248. The ring gear 246 may be supported by and rigidly coupled to the differential cage 248 or another example of the fourth housing. When supported, the ring gear 246 may be mechanically and structurally supported (e.g., supported via increasing tensile strength, compressive strength, sheer strength, and strain strength) via the differential cage 248 or other example of the fourth housing. The first side gear 252 may rigidly couple to the first axle shaft 236. The second side gear 254 may rigidly couple to the second axle shaft 238.

The first differential gear 256 and the second differential gear 258 are bevel gears, such as spider gears. The first differential gear 256 and the second differential gear 258 may be supported by the differential cage 248, such as to rotate with the differential cage 248, but spin freely of the differential cage 248. For example, the first differential gear 256 and the second differential gear 258 may be positioned radially about and supported by a common bushing 259.

The pinion gear 244 may mesh with the ring gear 246, and therein drive the ring gear 246, such that a plurality of teeth of the pinon gear mesh with other teeth of the ring gear. The ring gear 246 may drive the rotation of the differential cage 248. The differential cage 248 may drive the rotation of the first differential gear 256 and the second differential gear 258 around the axis 212. Likewise, the differential cage 248 may drive the spinning of the first differential gear 256 and second differential gear 258. The first differential gear 256 and second differential gear 258 may mate with the first side gear 252 and the second side gear 254. Teeth of the first side gear may mesh with other teeth of the first differential gear 256 and/or the second differential gear 258. Likewise, the teeth of the second side gear 254 may mesh with other teeth of the first differential gear 256 and/or the second differential gear 258. At least a side gear of the side gears 252, 254 has is selectively couplable to the differential cage 248. The clutch 241 may have a plurality of other locking features rigidly coupled to the side gear, that may lock with the locking features rigidly coupled to the differential cage 248. For example, the second side gear 254 may be selectively coupled to the differential cage 248 via the clutch 241 and via closing of the locking features rigidly coupled to the differential cage 248 and the other locking features rigidly coupled to the second side gear 254.

The differential cage 248 may be supported by a first bearing assembly 260, a piston bearing actuator system 262, and a second bearing assembly 264, allowing the differential cage 248 to rotated and spin independently of the housings of the axle assembly 202. For example, the first bearing assembly 260 may allow the differential cage 248 to rotate or spin independently of the first housing 228 and the second housing 232. The piston bearing actuator system 262 may allow the differential cage 248 to rotate or spin independently of the third housing 234. The second bearing assembly 264 may allow the differential cage 248 to rotate or spin independently of the first housing 228 and the third housing 234.

The piston bearing actuator system 262 is a part of the differential lock assembly 240. The piston bearing actuator system 262 is a piston assembly of a plurality of components that may be actuated, such as hydraulically, and close a clutch of the axle assembly. The piston bearing actuator system 262 comprises a piston 266, a bearing system 268, and an actuator 270. The piston 266 is a hydraulic piston that may be driven via hydraulic forces from pressure changes in a pressure chamber (e.g., a hydraulic pressure chamber). The pressure chamber may be referred to herein, as an actuation chamber 272. The actuation chamber 272 may be sandwiched longitudinally between the piston 266 and the third housing 234. The piston 266 and the actuator 270 may be hollow, each having through passages (e.g., through volumes), such as through holes. The piston 266 may be positioned around portions of the actuator 270. The bearing system 268 is sandwiched radially between the piston 266 and the actuator 270. The piston 266 may be an outer race for the bearing system 268. The actuator 270 may be an inner race of the bearing system 268.

The bearing system 268 comprises at least a bearing. It is to be appreciated, that the bearing system 268 may comprise a plurality of bearings. For example, the bearing system 268 may comprise a plurality of ball bearings.

The piston 266 and actuator 270 may be translated as a single unit in a direction parallel with the axis 212. The piston 266 may translate and press the actuator 270 via the one or more bearings of bearing system 268. The clutch of the clutch assembly may be opened and closed via the translation of the piston 266 and actuator 270.

The bearing system 268 may allow the actuator 270 to rotate and spin independently of the piston 266. Said in another way, the bearing system 268 allows the piston 266 to rotate and/or spin in different directions and at different rotational speeds from the actuator 270. For an example, while the piston 266 and actuator 270 spin around the axis 212, the actuator 270 and/or the differential cage 248 may spin at a first rotational speed and the piston 266 may spin at a second rotational speed, where the first rotational speed is a greater speed than the second rotational speed or vice versa. Additionally or alternatively, while the piston 266 and actuator 270 spin around the axis 212, the actuator 270 and/or the differential cage 248 may spin in a first rotational direction and the piston 266 may spin at a second rotational direction, where the first rotational direction is opposite the second rotational direction. For example, the first rotational direction may be clockwise and the second rotational direction may be counter clockwise or vice versa. Additionally, for these or other examples, the piston 266 may have a rotational speed of approximately zero (e.g., 0 rotations per minute (RPM)) and not rotate as the actuator 270 and/or the differential cage 248 rotate and spin around the axis 212 at another rotational speed.

The clutch 241 includes the drum 274 of the differential cage 248, or another example of the fourth housing, and a hub 278 that may be selectively coupled via a clutch pack. The locking features rigidly coupled to the differential cage 248 may be rigidly coupled to the drum. Likewise, the other locking features that rigidly couple to second side gear 254 may rigidly couple to the hub 278. The clutch pack may be a friction pack that when compressed presses a first set of frictional features and a second set of friction features together increasing frictional force, locking the clutch, and selectively coupling an input and output of the clutch the clutch pack is part thereof.

For an example, the clutch pack of the clutch 241 is a disk pack 276. The input is the drum 274 or another component of the differential cage 248. The output is the hub 278 of the actuator The differential cage 248 may rigidly couple to the drum 274. The second side gear 254 may rigidly couple to the hub 278. The differential cage 248 may comprise the drum 274. Likewise, the second side gear 254 may comprise the hub 278. The disk pack 276 may be positioned on the opposite side of a wall 280 of the differential cage 248 from a chamber of the differential cage 248 where the side gears 252, 254 and the differential gears 256, 258 may mate. The disk pack 276 is arranged axially between the wall 280 and the piston bearing actuator system 262. The wall 280 may have surfaces normal to the axis 212, and the wall 280 has a through volume, such as a through hole, a side gear and an axle shaft, such as the second side gear 254 and the second axle shaft 238, respectively, may extend through.

The clutch of the clutch assembly may be opened or closed via the translation of the actuator 270. The translation toward and pressing of the actuator on the clutch 241 may close the clutch 241. The translation away and removal of force from the actuator 270 from the clutch 241 may open the clutch 241.

Increase in pressure to the actuation chamber 272 may advance the piston 266 toward the clutch 241. More specifically, increase in pressure to the actuation chamber 272 may advance the piston 266 toward the disk pack 276. Upon advancing a first threshold of distance, the piston 266 may press upon and apply force to the disk pack 276. For example, when advanced via hydraulic forces, the piston 266 may be translated in the direction of the first side 204. Decreasing the pressure to the actuation chamber 272 may retract the piston away from the clutch and the disk pack 276. For example, when retracted via removal or reduction of hydraulic forces, the piston 266 may be translated in the direction of the second side 206.

Turning to FIG. 3, it shows a second view 300 of the area 210. The second view 300 is a portion of the first view 200, showing area 210 separate from other areas of the second view 300.

The piston 266 may comprise a first section 320 and a second section 322. The first section 320 may be a drum that curves radially about the actuator 270. The first section 320 comprises the outer race of the bearing system 268. The second section 322 may extend through the opening 282. The first section 320 may be cylindrical in shape. A disk 323 may connect the first section 320 and second section 322. The disk 323 extends radially outward from the second section 322 to the first section 320. The disk 323 may extend radially outward with respect to the axis 212.

A first seal 324 and a second seal 326 may curve radially about and be in contact with the piston 266. The first seal 324 and the second seal 326 may be ring like in shape and be liquid seals, such as O-rings. The first seal 324 may curve radially around and be in contact with the first section 320, and the second seal 326 may curve radially around and be in contact with the second section 322. A first groove 328 and a second groove 330 may be recessed in a radially outward direction into the material of the third housing 234. More specifically, the second groove 330 may be recessed radially into the rim 284 from the first opening 282. The first groove 328 and the second groove 330 may curve radially about the piston 266, such as when the piston 266 is housed by the second cavity 250. The first groove 328 may curve radially about the first section 320, and the second groove 330 may curve radially about the second section 322. The first seal 324 may be fit to and loaded in the first groove 328. Likewise, the second seal 326 may be fit to and loaded in the second groove 330. The first seal 324 and the second seal 326 may be fit to the first groove 328 and second groove 330, respectively, in a tongue and groove arrangement.

The first seal 324 and the second seal 326 may form fluid tight seals between the housing and the piston. The actuation chamber 272 may be formed at an axial distance along the axis 212 between the first seal 324 and the second seal 326. The actuation chamber 272 may be sandwiched between a first surface 332 of the housing and a second surface 334 of the disk 323. The first surface 332 may extend radially outward from the first opening. Likewise, the second surface 334 may extend radially outward from the second section 322. The first surface 332 and the second surface 334 may be flat and normal to the axis 212. The piston 266 comprises a third surface 336 and a fourth surface 338. The third surface 336 is an outer surface facing radially outward from the piston 266. The fourth surface 338 is an inner surface facing radially inward from the piston 266. The first section 320 comprises the third surface 336 and the fourth surface 338. The third surface 336 and the fourth surface 338 may curve radially around the axis 212 and be cylindrical or partially cylindrical in shape. The third surface 336 may have regions that are frustoconical in shape. The frustoconical portion of the third surface 336 may be contiguous with the second surface 334. The first seal 324 may contact and curve radially about the third surface 336.

The actuation chamber 272 may be supplied with fluid and pressurized via at least a port 340 and a channel 342. The port 340 may be in fluidic communication with a hydraulic fluid and pressure source. The channel 342 may be in fluidly coupled to the port 340 and the actuation chamber 272, placing the port 340 in fluidic communication with the actuation chamber 272.

The actuator 270 may comprise a land 343. The land 343 may extend radially outward from a fifth surface 344 of the actuator 270. The land 343 may be rounded, with rounded and beveled edges. In addition to the fifth surface 344, the actuator 270 comprises a sixth surface 345, a seventh surface 346, and an eighth surface 347. The fifth surface 344 and the eighth surface 347 may be outer surfaces of the actuator 270, wherein the fifth surface 344 and the eighth surface 347 face radially outward from the actuator 270. The fifth surface 344 and the eighth surface 347 may curve radially around the axis 212. The eighth surface 347 is also a surface of the land 343, where the eighth surface 347 may be cylindrical in shape and curve radially about the land 343. The fifth surface 344 may be contiguous with eighth surface 347. A portion of the fifth surface 344 may curve radially outward (e.g., radially above) in a frustoconical shape toward the eighth surface 347. The seventh surface 346 may be an inner surface, wherein the seventh surface 346 faces radially inward (e.g., radially below) from the actuator 270. The seventh surface 346 curves radially about the third opening 288. The seventh surface 346 may be cylindrical in shape. The sixth surface 345 may be flat and extend radially outward from the third opening 288. The sixth surface 345 may be contiguous with the seventh surface 346 and the eighth surface 347. The sixth surface 345 may be ring-like in shape. The sixth surface 345 may be normal to the axis 212. The sixth surface 345 may abut and press upon the disk pack 276.

The cavity 250 may house an insert 348. The insert 348 may be a ring like structure, such as a retainer ring. The insert 348 may physically couple to the third housing 234. For an example, the insert may physically couple a third groove 350, where the insert 348 is fit to the third groove 350 in a tongue and groove arrangement. The third groove 350 is recessed in a radially outward direction into the third housing 234 from the cavity 250. The third groove 350 may curve radially around the axis 212. The insert 348 may abut and prevent translation of the piston 266 past a point along axis 212. For example, the upon abutting the insert 348, the piston 266 may be prevented from translating along the axis 212 further in a direction toward the first side 204.

For example, the insert 348 may contact a ninth surface 364 of the piston 266. The ninth surface 364 may extend radially outward from a land 362 of the piston 266. The ninth surface 364 may be flat and ring like in shape. The land 362 may extend in an axial direction from the ninth surface 364, where axial is relative to the central axis and centerline of the piston 266. The land 362 may curve radially about the fourth opening 290.

The piston bearing actuator system 262 includes a pin 352. The pin 352 is a counter-rotation pin that may at least reduce and may prevent the piston 266 from rotating separately from the third housing 234. For example, the pin 352 may reduce the piston 266 from spinning about the axis 212. A fifth opening 354 is recessed into the third housing 234. More specifically, the fifth opening 354 is recessed into the rim 284 from the second surface 334. As sixth opening 356 is recessed into the piston 266. More specifically, the sixth opening 356 is recessed into the first section 320 from the second surface 334. The pin 352 may extend though the fifth opening 354 and the sixth opening 356.

The piston 266 and the actuator 270 may each comprise one or more outer race features and one or more inner race features, respectively. The outer race features may be features that retain the bearing system 268 as an outer race, and may slide and rotate around the bearing assembly (e.g., rotate freely there about the bearing assembly). Likewise, the inner race features may be features that retain the bearing system 268 as an inner race, and may slide and rotate within the bearing assembly (e.g., rotate freely therewithin the bearing assembly). The outer race features and inner race features may include a plurality of voids that may retain the components and features of the bearing system 268 and a plurality of smooth surfaces that are low friction around that are around and define volumes of the voids and contact the components and features of the bearing system 268. Low friction defined herein is a friction below a first desired threshold of friction. Below the first threshold of friction, the piston 266 and actuator 270 may rotate around while contacting bearing or bearings of the bearing system 268 below desired power losses of a second threshold of power loss and at or above a third threshold of rotational speed.

The piston 266 comprises a fourth groove 366, and the actuator 270 comprises a fifth groove 368. The fourth groove 366 may be recessed in a radially outward direction into the piston 266. Said in another way, the fourth groove 366 may have a ring like shape and volume, where the fourth groove 366 is depressed into the fourth surface 338. Likewise, the fifth groove 368 may be recessed in a radially inward direction into the actuator 270. Said in another way, the fifth groove 368 may have a ring-like shape and volume, where the fifth groove 368 is depressed into the fifth surface 344. The fourth and fifth grooves 366, 368 may be curved with a partially elliptical profile. For example, the fourth and fifth grooves 366, 368 may be semi-circular in profile. The bearing system 268 may be fit to the fourth groove 366 and the fifth groove 368.

The disk pack 276 includes a plurality of first plates 372 and a plurality of second plates 374. The first plates 372 may rigidly couple to the hub 278. The second plates 374 may rigidly couple to the drum 274. It is to be appreciated that the first plates 372 and the second plates 374 may be disks, where the first plates 372 and the second plates 374 may be a plurality of first disks and second disks, respectively. The first plates 372 and the second plates 374 are interleaved, where the plates may alternate such that second plate of the second plates 374 is located after each first plate of the first plates 372 in an axial direction, with respect to the first axis 212. The first plates 372 and the second plates 374 may be disks. For an example, the first plates 372 may be friction plates and the second plates 374 may be separator plates. However, for another example, the first plates 372 may be separator plates and the second plates 374 may be friction plates.

For an example, increasing the pressure to the actuation chamber 272 may advance the piston 266 in a first direction toward the first side 204 along axis 212. The actuator 270 may be translated with the piston 266. Upon advancing a first threshold of distance, the actuator 270 may press upon and apply force to the disk pack 276. More specifically, the sixth surface 345 may press upon the disk pack 276. The application of force from the pressing of the actuator 270 thereto may compress the disk pack 276. Compression of the disk pack 276 may press the first plates 372 to abut with the second plates 374, causing the clutch to engage in a closed state. Decreasing the pressure to the actuation chamber 272 may retract the piston 266 in the direction of the first side 204. The force of pressing from the actuator 270 may be reduced and/or removed from the disk pack 276 via being translated away from the disk pack 276 with the piston 266. The reduction or removal of force from the actuator 270 thereto may decompress the disk pack 276. During decompression of the disk pack 276, the first plates 372 may expand from the second plates 374, causing the clutch to disengage and enter an open state.

Returning to the piston 266, the first section 320 and the second section 322 have different inner and outer diameters. For example, the first section 320 has a first diameter 382 that is an outer diameter and a second diameter 384 that is an inner diameter. Likewise, the second section 322 may have a third diameter 386 that is an outer diameter and a fourth diameter 388 that is an inner diameter. The first diameter 382 is greater than the third diameter 386, and the second diameter 384 is greater than the fourth diameter 388. The third diameter 386 is a distance, such that the second section 322 may extend through and be fit to the first opening 282. The fourth diameter 388 is also the diameter of the second opening 286. As an inner diameter, the fourth diameter 388 may be the diameter of a passage volumetrically connected to the second opening extending through the piston 266.

The actuator 270 comprises a fifth diameter 390 that is an inner diameter. The seventh surface 346 curves radially about and touches the fifth diameter 390. The fifth diameter 390 is the diameter of the third opening 288. The fifth diameter 390 may be constant (e.g., a constant diameter) for the actuator 270 and the third opening 288, where the distance of the fifth diameter 390 does not change. Said in another way, a central passage or other volume extending through the actuator 270 may have a constant width and/or a constant diameter. Said in another way, the fifth diameter 390 may remain the same distance at different points along a centerline and central axis for the actuator 270. For example, when the actuator 270 is centered about the axis 212, the fifth diameter 390 may remain constant at different points along the axis 212. The fifth diameter 390 being constant may increase rigidity of the actuator 270 compared to an actuator with an inner diameter that changes. Likewise, the fifth diameter 390 being constant may increase the tensile strength and compressive strength of the actuator 270 compared to an actuator with an inner diameter that changes.

In this way, the disclosed system provides for an actuator assembly that includes a piston and an actuator that may close a clutch of a locked differential assembly, where the piston is an outer race and the actuator is the inner race for a bearing system of the assembly. The actuator assembly may be referred to alternatively as a piston bearing actuator system. The bearing system is one or more bearings that may be positioned radially between the piston and the actuator. The locked differential assembly is part of a larger axle assembly, where the axle assembly includes housing that houses the locked differential assembly and the actuator assembly. The bearing system may couple the piston and the actuator, such that the piston may translate and actuator, but the actuator may rotate and spin independently of the piston. Additionally, the piston may be prevented from rotating independently of the housing via a pin received by an opening of the housing and another opening of the piston. The piston may be driven to translate hydraulically, such as via oil pressure.

The disclosure also provides support for a differential lock assembly comprising: a differential, a friction pack, and a piston bearing actuator system comprising a piston, a bearing, and an actuator abutting the friction pack, where the piston is an outer race for the bearing and the actuator is an inner race for the bearing. In a first example of the system, the system further comprises: a pin, where the pin reduces rotation of the piston. In a second example of the system, optionally including the first example, there is a plurality of bearings between the actuator and the piston. In a third example of the system, optionally including one or both of the first and second examples, the bearings are ball bearings. In a fourth example of the system, optionally including one or more or each of the first through third examples including a differential cage for the differential, the differential cage comprising a drum, and a plurality of locking features of the friction pack rigidly coupled to the drum. In a fifth example of the system, optionally including one or more or each of the first through fourth examples includes a side gear for the differential, the side gear rigidly coupled to a hub, and a plurality of disks of the friction pack rigidly coupled to the hub, wherein the friction pack is a disk pack and selectively couples the side gear to a differential housing. In a sixth example of the system, optionally including one or more or each of the first through fifth examples, the side gear comprises the hub. In a seventh example of the system, optionally including one or more or each of the first through sixth examples, the piston is hollow with an opening that surrounds the actuator. In an eighth example of the system, optionally including one or more or each of the first through seventh examples, the actuator is hollow, and a shaft extends through a volume of the actuator. In a ninth example of the system, optionally including one or more or each of the first through eighth examples, the volume has a constant diameter. In a tenth example of the system, optionally including one or more or each of the first through ninth examples, the piston comprises a land, the land is extending in an axial direction from a surface of the piston. In an eleventh example of the system, optionally including one or more or each of the first through tenth examples, the actuator includes a land extending radially outward from the actuator. In a twelfth example of the system, optionally including one or more or each of the first through eleventh examples, a first surface and a second surface of the actuator are contiguous, the first surface and second surface are outer surfaces, the first surface curving radially outward toward the second surface, the second surface curving radially around the land. In a thirteenth example of the system, optionally including one or more or each of the first through twelfth examples, the friction pack is arranged between a differential housing for the differential and the piston.

The disclosure also provides support for an axle assembly comprising: a first housing, a first axle shaft, a second axle shaft, and a differential lock assembly including: a differential, a lock, and a piston bearing actuator system comprising: a piston, a bearing, and an actuator, where the piston bearing actuator system abuts and selectively closes the lock, where the piston is an outer race for the bearing and the actuator is an inner race for the bearing, and the lock selectively couples the first axle shaft to the differential. In a first example of the system, the differential includes a second housing that supports a plurality of side gears and differential pinion gears therein, and the lock includes a plurality of locking features rigidly coupled to the second housing, and the lock selectively couples a first side gear to the second housing. In a second example of the system, optionally including the first example, the lock is arranged between a wall of the second housing and the piston bearing actuator system and opposite the wall from a chamber of the second housing where teeth of the side gears mate with other teeth of the differential pinion gears. In a third example of the system, optionally including one or both of the first and second examples, the piston bearing actuator system is hydraulically actuated. In a fourth example of the system, optionally including one or more or each of the first through third examples including a hydraulic pressure chamber positioned between the first housing and the piston bearing actuator system, and the first housing includes at least a port fluidically coupled to the hydraulic pressure chamber.

Turning to FIG. 4, it shows a method 400 for manufacturing an axle assembly of the present disclosure, such as the piston bearing actuator system 262 of FIG. 2. Method 400 is also a method of assembly the piston bearing actuator system into an axle assembly of the present disclosure, such as axle assembly 202 of FIG. 2

Method 400 starts at 402, where the components and features of the axle assembly are gathered and arranged for assembly. Said in another way, at 402 method includes gathering and arranging the components for assembly. For example, components and features of the axle assembly may include one or more of a plurality of axle housings including a first differential housing, such as a differential carrier, differential cover, or other differential housing; and, axle shaft housings. Likewise, components include the components of the clutch assembly, such as differential lock assembly 240 of FIG. 2. The components of the clutch assembly include a differential cage including a drum section and side gear including a hub section installed with a clutch pack. The differential cage, the side gear, and the clutch pack may be the differential cage 248, the second side gear 254, and the disk pack 276 of FIG. 2, respectively. The plates of the clutch pack may be interleaved, such that the clutch pack may be closed and selectively couple the drum section and hub section. Likewise, the differential cage and side gear may be preassembled and installed as a single unit, with the plates of the clutch pack interleaved. The components of the clutch assembly also include components of the piston bearing actuator system, where the piston bearing actuator system is disassembled. The piston bearing actuator system components include a piston, a bearing system that may be one or more bearings, and an actuator such as the piston 266, the bearing system 268, and the actuator 270 of FIG. 2.

402 may include arranging and coupling components and features of the axle assembly to fixtures or mounts reducing movement to the components or features below a desired threshold of distance. Components secured via an adjustable brace or a fixture such that the components and features can be moved deliberately or held at rest for other components to be assembled thereon.

Following 402, method 400 may progress to 412, where the piston bearing actuator system is assembled. 412 includes a plurality of sub-steps. 412 begins at 414, where the actuator is secured to reduce movement. Said in another way, at 412, method 400 includes securing the actuator reducing movement thereof. The reduction of movement may prevent movement of the actuator. Securing may be accomplished via fixing the actuators in place via a fixture assembly or a mount.

Method 400 continues to 416, where the bearing system is assembled onto and radially about the actuator. Said in another way, at 416, method 400 includes assembling the bearing system around the actuator, and installing and fitting the bearing system to the inner race features the actuator. Installation and fitting may be through loading the components and features of the bearing system into one or more inner races features of the actuator. Loading the bearing system into the inner race features of the actuator may include loading the one or more bearings of the bearing system into a groove of the actuator, and into contact with the surfaces therearound. The groove, may be referred to herein as a first bearing groove. Said in another way, during 416, method 400 includes guiding the bearing system around the actuator, and then fitting the bearing system around the actuator such that the inner race features and actuator may rotate and slide within the bearing system while in contact therein.

For example, method 400 may include loading one or more bearings into the first bearing groove of the piston, such as the fifth groove 368 of FIG. 2. The bearings may be ball bearings, and may be loaded and fit to the inner race features. The bearing or bearings of the bearing system are secured in place reducing movement or dislodgement from the inner race features.

For example, at 416, method 400 may include installing a brace or a fixture to reduce movement of components of the bearing system in an outward direction (e.g., radially outward or radially above) from groove or grooves and/or out of contact with the other inner race features of the actuator. The reduction of movement to components of the bearing system in the outward direction may also prevent movement thereto. If the bearing system comprises a plurality of bearings, the bearings may be spaced equidistantly and radially about the first bearing groove.

Method 400 continues 418, where the piston is assembled radially around the bearing system and the actuator. More specifically, a section of the piston that comprises an outer race is assembled radially around the bearing system and the actuator. Said in another way, at 418, method 400 includes positioning the piston around the actuator, and positioning piston such that one or more outer race features of the actuator are open for installing and fitting the bearing system thereto. The outer race features may include another groove, referred to herein as a second bearing groove, of the piston and the surface that define and are around the volume of the groove. During 418, the second bearing groove of the piston, such as the fourth groove 366, is arranged radially around the bearing system. Said in another way, during 418, method 400 includes guiding the outer race features of the actuator around the bearing system, and then fitting the outer race features around the bearing system such that the outer race features and piston may rotate and slide around the bearing system while in contact therein. Said in another way, 418 includes positioning the bearing or bearings, such as ball bearings, of the bearing system between the inner race features and the outer race features. The bearing system may therein be received and loaded into the second bearing groove. 418 may include removing the brace or fixture as a piston is positioned around the actuator and in contact with the bearing system. The walls of the piston and eventually the outer race features are holding the bearing system in place, reducing movement of the bearing system below another threshold of distance.

For example, at 418, method 400 may include translating the piston around the bearing assembly until the piston reaches a first threshold of distance, where at the first threshold of distance the piston begins sliding around the bearing system. Alternatively, method 400 may include translating the actuator and the bearing assembly through an opening of the piston until the bearing system reaches the first threshold of distance. Method 400 includes sliding the piston or, alternatively, the actuator and the bearing assembly to a second threshold of distance, where at the second threshold of distance the bearing system fits and loads into the second bearing groove. Sliding the of the piston around the bearing system may be accomplished via pushing or pulling at a force above a third threshold of force. Likewise, sliding the bearing system through the piston may be accomplished via a pushing or pulling at a force above a fourth threshold of force. Upon insertion into the second bearing groove, the piston is decouplable from the actuator and the bearing system via a deliberate force applied to the piston greater than the third threshold of force. Likewise, the actuator and bearing system is decouplable from the piston via a deliberate force applied to the actuator and bearing system greater than the third threshold of force. The third threshold of force and the fourth threshold of force may be equal.

After 418, 412 finishes forming the piston bearing actuator system from the piston, the bearing system, and the actuator, such that the actuator is spinable at different directions and rotational speeds from the piston and vice versa. After 418, 412 ends and method 400 continues.

Method 400 progresses from 412 to 422, where the clutch assembly is installed into the axle housings of an axle. More specifically, at 422, method 400 includes installing the clutch assembly into the differential housing, such as the first housing 228 of FIGS. 2-3. Further 422 includes installing the clutch assembly into another axle housing, such as the third housing 234 of FIGS. 2-3, of a plurality of axle housings including the differential housing.

422 includes a plurality of sub-steps. 422 begins at 424, where the piston bearing actuator system is installed into a complementary cavity of the axle housing. Said in another way, at 424, method 400 includes installing the piston bearing actuator system into the complementary cavity of the axle housing or axle housings. The complementary cavity is a cavity that supports and encloses the piston bearing actuator system, such that an actuation chamber is created between the piston bearing actuator system and the complementary cavity. Said in another way, 422 includes forming a pressure chamber for actuating piston bearing actuator system between the piston bearing actuator system and the axle housing. The piston bearing actuator system is inserted into a first opening to the complementary cavity of the axle housing(s). The piston bearing actuator system is guided through a second opening of the complementary cavity. More specifically, a second section of the piston is guided through the second opening.

The piston bearing actuator system may be positioned to abut a surface of the complementary cavity that may be normal to the rotational axis of the axle assembly and be in fluid communication with an opening to a port to a pressure and hydraulic fluid source. The complementary cavity includes at least two seals that are positioned about and create a fluid tight seal between the housing and the piston. Positioning the bearing actuation system to abut against the surface normal to the rotational axis and fluidically seal to other surfaces of the complementary cavity, forms the pressure chamber for actuating piston bearing actuator system.

After 424, method 400 proceeds to 426, that is an optional where the clutch pack is installed with the clutch drum, clutch pack, and rigidly coupled components into the complementary cavity. The clutch pack is arranged such that the actuator of the piston actuator assembly abuts the clutch pack when translated away from the surface a fifth threshold of distance. For a first example, the clutch pack is preinstalled and the clutch drum, clutch pack, and other components are assembled into a differential assembly of the present disclosure.

For a second example, 426 may optionally include installing the clutch pack and assembling the differential assembly and differential of the present disclosure. Installing the clutch drum includes installing the differential cage or other differential case, and may further include installing a larger differential assembly thereof. The differential cage may be the differential cage 248 of FIGS. 2-3. Likewise, installing a clutch hub for the clutch pack includes installing a side gear to be supported and housed via the differential case, such as the differential cage. Installing the clutch pack may include rigidly coupling a plurality of first plates, such as first disks, to the clutch drum, and rigidly coupling a plurality of second plates, such as second disks, to the clutch hub. Further, installing the clutch pack may include interleaving the first plates and the second plates. Said in another way, the differential cage of the clutch drum and at least the side gear including the clutch hub are assembled into a differential system.

Further, 426 includes positioning the differential cage or other differential case such that the piston bearing actuator system and, more specifically, the actuator, may contact the clutch pack via translation. Said in another, way at 426, method 400 includes positioning the piston bearing actuator system between the differential system, including the differential thereof, and the axle housing. Further, 426 includes positioning the clutch pack between the differential and the actuator, and the clutch selectively couples the differential cage or other differential case to the side gear via locking (e.g., closing) and selectively coupling the drum and hub. Said in another way, the clutch pack is a lock for locking and rigidly coupling the differential cage or other differential case to the side gear. When positioned as described via 426 of method 400, the clutch pack is pressable via the piston bearing actuator system and, more specifically, the actuator. Further, the clutch pack may be closed via pressing a plate or another feature of the clutch pack via the actuator.

Method 400 continues to 432 where the axle housing is assembled to the differential housing, where the differential housing may be a differential carrier. During assembly at 432, the differential carrier or other differential housing, such as a differential cover, is then physically coupled and rigidly coupled to the axle housing. Said in another way, during assembly at 432, method 400 includes rigidly coupling the differential housing to a plurality of axle housings. Rigidly coupling the differential housing to the plurality of axle housings may be through fastening the axle housings to the differential housing via one or more fastener(s). The differential carrier or other differential housing is positioned about and encloses the differential system and differential thereof, including the differential case. Further, the differential carrier or other differential housing and the axle housing is positioned about and encloses the differential assembly and the piston bearing actuator system.

After 432, method 400 ends.

In this way, is disclosed a method for a procedure to assemble a piston bearing actuator system of the present disclosure, and assemble the piston bearing actuator system and other components of a locked differential assembly into the housings of an axle assembly. The piston bearing actuator system includes a piston, an actuator, and a bearing assembly of one or more bearings arranged therebetween. Where the piston and the actuator are an inner race and an outer race, respectively, for the bearing assembly.

The disclosure also provides support for a method for assembling a piston assembly into a differential system including: securing an actuator, positioning the actuator so one or more inner race features of the actuator are open for installing and fitting of a bearing system thereto, assembling the bearing system around the actuator, fitting the bearing system to the inner race features, securing the bearing system in place, positioning a piston around the actuator, positioning the piston so one or more outer race features of the actuator are open for installing and fitting of the bearing system thereto, guiding the outer race features of the piston around the bearing system, fitting the outer race features around the bearing system, and forming a piston bearing actuator system from the piston, the bearing system, and the actuator such that the actuator is spinable within the piston at different directions and rotational speeds from the actuator.

Additionally, it is to be appreciated for another embodiment, The disclosure also provides support for a method for assembling a differential system including: securing an actuator, positioning the actuator so one or more inner race features of the actuator are open for installing and fitting of a bearing system thereto, assembling the bearing system around the actuator, fitting the bearing system to the inner race features, securing the bearing system in place, positioning a piston around the actuator, positioning the piston so one or more outer race features of the actuator are open for installing and fitting of the bearing system thereto, guiding the outer race features of the actuator around the bearing system, fitting the outer race features around the bearing system, and forming a piston bearing actuator system from the piston, the bearing system, the actuator such that the actuator is spinable within piston in different directions and rotational speeds, and the piston is spinable around the actuator in different directions and rotational speeds. In a first example of the method including positioning the piston bearing actuator system between a differential and a housing around the differential of the differential system, and forming a pressure chamber for actuating piston bearing actuator system between the piston bearing actuator system and the housing. In a second example of the method, optionally including the first example including positioning a plurality of ball bearings between the inner race features of the actuator and the outer race features of the piston. In a third example of the method, optionally including one or both of the first and second examples including positioning a lock between the differential and the actuator, positioning the lock to be pressable via the actuator, and assembling the lock to selectively couple a second housing of the differential to a side gear of the differential. In a fourth example of the method, optionally including one or more or each of the first through third examples, the lock includes a disk pack, rigidly coupling a plurality of first disks to a differential carrier, rigidly coupling a plurality of second disks to the side gear, and interleaving the first disks and the second disks.

Turning to FIG. 5, it shows a method 500 for closing a clutch for a differential locking system of an axle assembly via a piston bearing actuator system 262 of the present disclosure, such as the clutch 241 and the piston bearing actuator system 262 of FIG. 2. Method 500 closes the clutch such that the differential assembly is locked distributing splitting torque and other rotational energy to differential approximately equally between the side gears and axle shafts of the differential system. For example, the closing of the clutch via method 500 may split torque and rotational energy through the differential to be approximately the same to each the axle half shafts of the differential assembly, such as the first axle shaft 236 and the second axle shaft 238. Further, the closing of the clutch via method 500 may selectively couple axle half shafts to the differential to rotate as a unitary structure.

Method 500 may optionally begin at 502, and including driving and rotating the differential of the differential assembly and the axle assembly. At 502 the differential receives torque or rotational energy from an input. For example, the differential includes receiving torque from rotational input drivingly coupled to an input gear rigidly coupled to a housing of the differential, such as receiving torque from the rotation from the drive shaft 242 and pinion gear 244 the ring gear 246 of FIG. 2.

Method 500 may continue from 502 to 504. 504 is another optional step and includes distributing a first rotational energy and a second rotational energy (e.g., a first torque and a second torque, respectively) to drive a first axle shaft and a second axle shaft, respectively. The first rotational energy and the second rotational energy are of different amounts and drive the first axle shaft and the second axle shaft, respectively, at different rotational speeds. The distribution of different rotational energies to opposite axle shafts may occur during specific events, such as turning of the axle system. It is to be appreciated that 502 and 504 are optional steps, and method 500 may skip 502 and 504.

Method 500 may continue from 504 or alternatively start at 506. Method 500 includes opening a port and, more specifically a hydraulic port, to a pressure and fluid source at 506. The fluid is a liquid and more specifically hydraulic fluid. Method 500 continues to 510, where opening the port includes increasing fluid flow and hydraulic pressure to and through the port and in an actuation chamber for the piston bearing actuator system. The actuation chamber is a pressure chamber and more specifically a hydraulic actuation chamber, for actuating piston bearing actuator system.

Method 500 continues to 512, increasing the pressure of the hydraulic pressure above a first threshold of pressure and advancing (e.g., actuating) the piston bearing actuator system in a first direction. Increasing the hydraulic pressure to or above the first threshold of pressure places a force great enough against a piston of the hydraulic piston system to translate and, more specifically, slide the hydraulic piston system in the first direction, expanding the actuation chamber. The first direction is a direction toward the and normal to a lock for the differential system. The lock may be or part of a friction clutch that includes clutch pack (e.g., a friction pack). More specifically, the clutch pack may be a disk pack.

Method 500 continues to 514 advancing the piston bearing actuator system into surface sharing contact with the lock. After advancing into contact with the lock, method 500 further includes pressing an actuator of the piston bearing actuator system against the lock at 516. The lock is or includes a clutch, and more specifically, method 500 includes pressing the piston against the friction pack of the clutch, and therein squeezing and closing the friction pack. The pressing of the lock closes the lock, selectively coupling at least a side gear to a differential housing of the differential. Further pressing the lock selectively couples the differential to the axle shafts of the axle assembly, such that the differential and axle shafts are locked and rotate as a single unitary element.

In this way, is disclosed is a method of closing a clutch and locking a side gear to a differential and an axle shafts rigidly coupled thereto via hydraulically actuating the piston bearing actuator system. Where the piston bearing actuator system includes a piston, an actuator, and a bearing assembly of one or more bearings arranged therebetween. Where the piston and the actuator are an inner race and an outer race, respectively, for the bearing assembly.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A differential lock assembly comprising:
a differential;
a friction pack; and
a piston bearing actuator system comprising a piston, a bearing, and an actuator abutting the friction pack, where the piston is an outer race for the bearing and the actuator is an inner race for the bearing.

2. The differential lock assembly of claim 1, further comprising a pin, where the pin reduces rotation of the piston.

3. The differential lock assembly of claim 1, wherein there is a plurality of bearings between the actuator and the piston.

4. The differential lock assembly of claim 3, wherein the bearings are ball bearings.

5. The differential lock assembly of claim 1, including a differential cage for the differential, the differential cage comprising a drum, and a plurality of locking features of the friction pack rigidly coupled to the drum.

6. The differential lock assembly of claim 1, includes a side gear for the differential, the side gear rigidly coupled to a hub, and a plurality of disks of the friction pack rigidly coupled to the hub, wherein the friction pack is a disk pack and selectively couples the side gear to a differential housing.

7. The differential lock assembly of claim 6, where the side gear comprises the hub.

8. The differential lock assembly of claim 1, wherein the piston is hollow with an opening that surrounds the actuator.

9. The differential lock assembly of claim 8, wherein the actuator is hollow, and a shaft extends through a volume of the actuator.

10. The differential lock assembly of claim 9, wherein the volume has a constant diameter.

11. The differential lock assembly of claim 1, wherein the piston comprises a land, the land extending in an axial direction from a surface of the piston.

12. The differential lock assembly of claim 1, wherein the actuator includes a land extending radially outward from the actuator.

13. The differential lock assembly of claim 12, wherein a first surface and a second surface of the actuator are contiguous, the first surface and second surface are outer surfaces, the first surface curving radially outward toward the second surface, the second surface curving radially around the land.

14. The differential lock assembly of claim 1, wherein the friction pack is arranged between a differential housing for the differential and the piston.

15. An axle assembly comprising:
a first housing;
a first axle shaft;
a second axle shaft; and a
differential lock assembly including:
a differential;
a lock; and
a piston bearing actuator system comprising: a piston, a bearing, and an actuator, where the piston bearing actuator system abuts and selectively closes the lock, where the piston is an outer race for the bearing and the actuator is an inner race for the bearing, and the lock selectively couples the first axle shaft to the differential.

16. The axle assembly of claim 15, where the differential includes a second housing that supports a plurality of side gears and differential pinion gears therein, and the lock includes a plurality of locking features rigidly coupled to the second housing, and the lock selectively couples a first side gear to the second housing.

17. The axle assembly of claim 16, where the lock is arranged between a wall of the second housing and the piston bearing actuator system and opposite the wall from a chamber of the second housing where teeth of the side gears mate with other teeth of the differential pinion gears.

18. The axle assembly of claim 16, where the piston bearing actuator system is hydraulically actuated.

19. The axle assembly of claim 17, including a hydraulic pressure chamber positioned between the first housing and the piston bearing actuator system, and the first housing includes at least a port fluidically coupled to the hydraulic pressure chamber.

20. A method for assembling a piston assembly into a differential system including:
securing an actuator;
positioning the actuator so one or more inner race features of the actuator are open for installing and fitting of a bearing system thereto;
assembling the bearing system around the actuator;
fitting the bearing system to the inner race features;
securing the bearing system in place;
positioning a piston around the actuator;
positioning the piston so one or more outer race features of the actuator are open for installing and fitting of the bearing system thereto;
guiding the outer race features of the piston around the bearing system;
fitting the outer race features around the bearing system; and
forming a piston bearing actuator system from the piston, the bearing system, and the actuator such that the actuator is spinable within the piston at different directions and rotational speeds from the actuator.
